(19) United States
(12) Patent Application Publication
(10) Pub. No.: US 2007/0091423 A1
(43) Pub. Date: Apr. 26, 2007

(54) Weight loss method and apparatus

(76) Inventors: Philip R. Belzunce, Rocky River, OH (US); Lalei E. Gutierrez, Rocky River, OH (US)

Correspondence Address: BROUSE MCDOWELL LPA, 388 SOUTH MAIN STREET, SUITE 500, AKRON, OH, 44311, US

(21) Appl. No.: 11/405,063

(22) Filed: Apr. 17, 2006

Related U.S. Application Data
(60) Provisional application No. 60/671,634, filed on Apr. 15, 2005.

(51) Int. Cl. F21V 9/04

(52) U.S. Cl. 359/360

(57) ABSTRACT

The present invention discloses a mirror that is adapted with at least two portions, that allow the associated user to see what he or she may look like if weight is gained and, conversely, if weight is lost. The apparatus may include a third, substantially planar mirror portion to reflect an undistorted image of the user. The three mirror portions may be distinct mirrors, which may be pivotably attached to each other. The apparatus may further include one or more means for stimulating and reinforcing the images in the mirror, which may include auditory, visual, and olfactory stimulating means. Methods of using the apparatus are also presented.

This invention claims priority to U.S. Provisional Patent Application No. 60/671,634 filed on Apr. 15, 2005.

### I. BACKGROUND OF THE INVENTION

A. Field of Invention

This invention relates to the art of methods and apparatuses for controlling weight and encouraging weight loss.

B. Description of the Related Art

Obesity is one of the most significant health crises to impact the developed world. Obesity and, more generally, weight related health disorders, such as high blood pressure, diabetes, high cholesterol, anorexia and bulimia, are directly impacting millions of people of all ages—becoming endemic in many societies. In the United States, treatments for obesity are being developed at a rapid pace. Most of these treatments consist of one or more of a diet regimen, the use of unregulated and regulated drugs or pharmaceuticals, or, in recent years, invasive surgical techniques. While the efficacy of these measures varies significantly, each has significant drawbacks. Dieting often fails to produce long term lasting effects. Diets require significant discipline and sacrifice over a long period of time leading to a change in lifestyle and eating habits. Many who start diets quickly give up or are frustrated by the lack of immediate success. The prospect of rapidly losing and gaining weight can be extremely unhealthy. Drug therapies are costly and may be unsafe. Surgical treatments for weight loss can be extremely dangerous and debilitating. Despite these limitations, significant resources are spent each year pursuing weight loss.

Though more and more people are looking to traditional therapies for losing weight, the population continues to struggle with weight related problems, suggesting that the existing treatments do not fully address the underlying problems leading to weight gain and poor body image. In part, the poor success of traditional weight loss therapies and diets over the long term, may be tied to the failure of these to address and treat the mental aspects of healthy living and eating. Individuals may look to rely on a pharmaceutical or other medical intervention to solve a problem without addressing psychological factors. Alternatively, individuals may look for quick results from the latest diet, and, not seeing the results, soon give up. Diets, food deprivations, drugs, and surgical interventions that do not address the psychological aspects of eating and body image, which are key components to maintaining a healthy lifestyle, including a healthy weight, may simply not work over the long term.

In recent years, there has been a renewed interest in holistic approaches to encouraging weight loss, that involve, among other things, addressing and treating the psychological precursors of unhealthy eating habits. These approaches, which may or may not include special diets, often rely on imagery, positive and negative feedback, visualization, and sensory stimulation, to improve body image and thereby encourage positive behaviors. These approaches have the benefit of being non-invasive and non-debilitating, while addressing mental and emotional causes leading to poor or self-destructive eating habits. It would be desirable to provide a method and associated apparatus that incorporates a plurality of holistic elements into a single, simple system that is compact and readily accessible so that it can be practiced discretely and at will by the associated user.

Mirrors are useful tools for providing immediate feedback on image. It is well known to look into a mirror when dressing or otherwise to check on one's appearance. Most mirrors are planar layers of a transparent material that have been silvered on one side. The reflection in the silvering provides an image. Planar mirrors afford essentially no magnification or miniaturization of objects in the mirror. What is reflected is an accurate reflection in size and shape of what is facing the mirror. It is also known to provide mirrors that have the effect of magnifying objects. These mirrors may be convex in shape, though other means of providing magnification may be known. Magnifying mirrors are often used in the application of cosmetics, though other applications are known.

It is additionally known to combine in one apparatus, a planar mirror and a magnifying mirror. Mirrors marketed in relation to cosmetics often include one or more planar mirrors in combination with one or more magnifying mirrors. The magnifying mirrors may provide more than one level of magnification.

Magnifying mirrors, by their design, reflect an image that is much larger than the actual object in the mirror. Such a mirror may have the effect of simulating weight gain, though no device is known to be marketed for such a purpose. In the same manner, no device is known which incorporates a mirror that reduces or miniaturizes the image as compared to planar mirror, in combination with one or more of a planar mirror or magnifying mirror.

### II. SUMMARY OF THE INVENTION

The present invention provides a method and apparatus that combines one or more of the elements of imagery, feedback, visualization, and sensory stimulation, to assist associated users in coping and addressing their obesity or other eating related disorders. More specifically, the methods of the present invention may incorporate a novel means of visualization; namely, a mirror that is adapted with two, or in another embodiment, three portions, wherein the associated user may be able to see what he or she presently looks like, what he or she may look like if weight is gained or, conversely, if weight is lost. The visualization provided by the mirror, by itself, or in combination with other aspects of the method, provides a physical picture that can assist the associated user in making healthy eating choices, seeing a goal and gaining a positive body image.

The mirror apparatus may have additional further applications as discussed in this application, apart from the methods taught herein.

According to one aspect of the present invention, an apparatus comprised of two mirror portions or three mirror portions is taught for use as a weight loss device.

According to another aspect of the present invention, the apparatus includes at least a concave mirror portion and a convex mirror portion, and in an embodiment with three mirror portions, a planar mirror portion.

According to another aspect of the present invention, the mirror portions are independent mirrors.

According to another aspect of the present invention, the mirror portions are hingedly attached adjacent each other.

According to yet another aspect of the present invention, the mirror portions are removably, hingedly attached adjacent each other.

According to yet another aspect of the present invention, the apparatus further includes a visual stimulating means.

According to yet another aspect of the present invention, the visual stimulating means may be a light array.

According to yet another aspect of the present invention, the apparatus further includes an auditory stimulating means.

According to yet another aspect of the present invention, the auditory stimulating means may be a music player.

According to yet another aspect of the present invention, the apparatus further includes an olfactory stimulating means.

According to another aspect of the present invention, a weight loss method is taught which includes the steps of visualization in the apparatus described herein and positive and negative self-affirmations.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIGS. 1A-1D depict a top view, front view, side view and back view respectively of the apparatus 1, according to one embodiment of the present invention, the apparatus comprising two mirror portions, one mirror portion 20 being concave and the other mirror portion 10 being convex.

FIGS. 2A-2D depict a top view, front view, side view and back view respectively of a smaller version of the apparatus 1 shown in FIGS. 1A-1D, the apparatus being suitable for use in a bathroom or vanity room.

FIGS. 3A-3D depict a top view, front view, side view and back view respectively of a another smaller version of the apparatus I shown in FIGS. 1A-1D, the apparatus 1 being suitable for use on a tabletop.

FIGS. 4A-4D depict a top view, front view, side view and back view respectively of respectively of the apparatus 1, according to an alternate embodiment of the present invention, the apparatus comprising three mirror portions, one mirror portion 10 being magnifying, the second mirror portion 20 being miniaturizing, and the third mirror portion 40 being planar.

FIGS. 5A-5D depict a top view, front view, side view and back view respectively of a smaller version of the apparatus 1 shown in FIGS. 4A-4D, the apparatus 1 being suitable for use in a bathroom or vanity room.

FIGS. 6A-6D depict a top view, front view, side view and back view respectively of a another smaller version of the apparatus 1 shown in FIGS. 4A-4D, the apparatus 1 being suitable for use on a tabletop.

### IV. DESCRIPTION OF THE PREFERRED EMBODIMENT

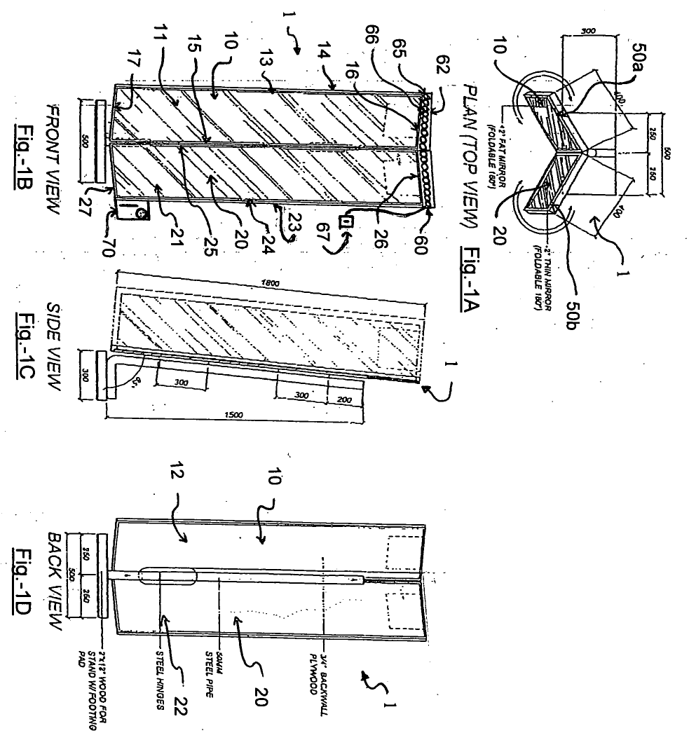

Referring now to the drawings wherein the showings are for purposes of illustrating various embodiments of the invention only and not for purposes of limiting the same, FIGS. 1A-1D, 2A-2D, and 3A-3D (collectively referred to as FIGS. 1, 2, and 3 respectively) generally represent a first broad embodiment of the apparatus 1 of the present invention. Shown in FIGS. 1, 2, and 3 is an apparatus 1 comprising a first mirror portion 10, which may be arcuate and which may be a convex mirror, and a second mirror portion 20, which may be arcuate and which may be a concave mirror, positioned adjacent each other. Specific variations between the embodiments depicted in FIGS. 1, 2, and 3 respectively, will be discussed in greater detail below.

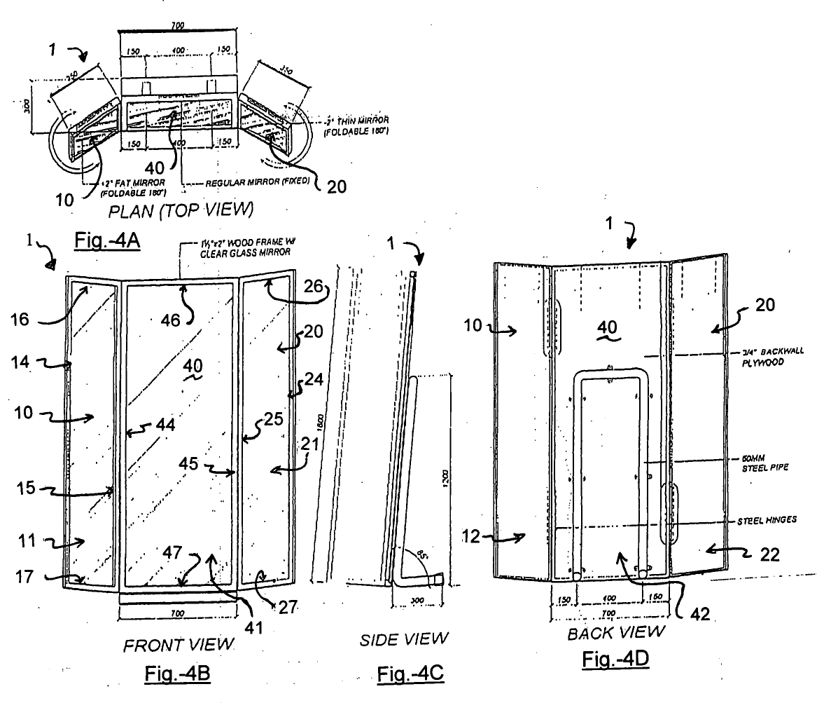

FIGS. 4A-4D, 5A-5D, and 6A-6D (collectively referred to as FIGS. 4, 5, and 6 respectively) generally represent a second broad embodiment of the apparatus 1 of the present invention. Shown in FIGS. 4, 5, and 6 is an apparatus 1 comprising a first mirror portion 10, which may be arcuate and which may be a convex mirror, and a second mirror portion 20, which may be arcuate and which may be a concave mirror, and a third substantially planar mirror portion 40. Specific variations between the embodiments depicted in FIGS. 4, 5, and 6 respectively, will also be discussed in greater detail below.

With reference to FIGS. 1-6, the mirror portions 10, 20, 40 referred to above will be described in greater detail.

The Arcuate Mirror Portions:

Each of the embodiments depicted in FIGS. 1-6 include at least two mirror portions 10, 20 that each serve to distort, and preferably to magnify or miniaturize respectively, objects placed in front of the mirror. The term “mirror” generally refers to any surface capable of reflecting sufficient undiffused light to form an image of an object placed in front of it; however, the term “mirror” will be understood as referring to an article that is comprised of a transparent layer, typically glass, and a reflective layer deposit thereon, which may be a silver foil or other metallic coating.

In each of the embodiments represented in FIGS. 1-6, there is a first mirror portion 10 that is a magnifying mirror portion and there is a second mirror portion 20 that is a miniaturizing or minimizing mirror portion. It is a specific object of the first mirror portion 10 that objects placed before it will appear larger than normal, in at least one dimension. In this respect, the first mirror portion 10 is a magnifying mirror portion and may be said to reflectively magnify an object placed before the mirror. Magnification may be from greater than about 1.1 times normal size to as much as 5 times normal size, with a range of about 1.5 times to about 2.5 times normal preferred. Levels of magnification greater than five times normal size may be created in the first mirror portion 10.

By stating that the magnification is in “at least one dimension”, it is contemplated that the magnification may be in less than all dimensions. While the first mirror portion 10 may magnify the object so that the reflected image is proportionately larger in all dimensions, the first mirror portion 10 may magnify the object disproportionately, so as to magnify, for example, the associated object's width (the horizontal dimension) while accurately reflecting the object's height (vertical dimension). It may be desirable, for example, to selectively magnify the object's width so as to depict weight gain. It would not be as desirable, under those circumstances, to magnify the object's height, which would generally be unaffected by weight gain. It will be understood that this disproportionate, or alternatively, proportionate magnification, may depend on the structure of the first mirror portion 10 and that the first mirror portion 10 may be constructed to magnify selected dimensions.

It is a specific object of the second mirror portion 20 that objects placed before it will appear smaller than normal, in at least one dimension. In this respect, the second mirror portion 20 is a miniaturizing or minimizing mirror portion 20 and may be said to reflectively miniaturize an associated object placed before the mirror. Miniaturization may be from about 0.99 times normal size to about 0.25 times normal size, with a range of about 0.9 times to about 0.5 times normal preferred. Levels of miniaturization less than 0.25 times normal size may be created in the second mirror portion 20.

As with the first mirror portion 10, stating that the miniaturization is in at least one dimension, means that, while the second mirror portion 20 may miniaturize the object so that the reflected image is proportionately smaller in all dimensions, the second mirror portion 20 may miniaturize the object disproportionately and in less than all dimensions, so as to miniaturize, for example, the object's width, while substantially, accurately reflecting the object's height. It will be understood that this disproportionate, or alternatively, proportionate miniaturization, may also depend on the structure of the second mirror portion 20.

Each mirror portion 10, 20 may have a front face 11, 21, a rear face 12, 22, and at least a first edge 13, 23. The mirror portions 10, 20 may be any shape, though round, square, and rectangular mirror portions 10, 20 are preferred shapes. The first and second mirror portions may be arcuate, meaning at least one of the front 11, 21 and rear faces 12, 22 of the mirror may be curved to achieve the respective, desired level of magnification (as in the first mirror portion 10) or miniaturization (as in the second mirror portion 20).

It will be understood that various methods of achieving magnification, with respect to the first mirror portion 10, or miniaturization, with respect to the second mirror portion 20, are permissible within the scope of the present invention. Magnification and miniaturization may be achieved by bending the mirror or by varying the thickness of portions of the mirror, as in a lens. As shown in FIGS. 1-6, magnification in the first mirror portion 10 may be achieved by means of a convex mirror. As shown more specifically in FIGS. 1A, 2A, 3A, 4A, 5A, and 6A, the front face 11 of the first mirror portion 10 may be curved outwardly (convexly). As further shown in FIGS. 1A-6A, the first mirror portion 10 may be semi-cylindrical. By “semi-cylindrical” it is meant that the mirror may be formed in the shape of a portion of the wall of a hollow cylinder or tube. A semi-cylindrical mirror may achieve magnification of the object's width, while substantially, accurately reflecting the object's height. This is the preferred embodiment for weight loss related applications, though, in other applications, it may be preferable to selectively magnify the object's height rather than width, and in still other embodiments, it may be desirable to proportionately magnify the entire object.

The amount of magnification may depend on the curvature of the front 11, 21 and/or rear 12, 22 faces of the mirror. However, the amount of magnification may depend on other factors, including the thickness of the transparent layer of the mirror.

Miniaturization in the second mirror portion 20 may be achieved by means of a concave mirror. As shown more specifically in FIGS. 1A, 2A, 3A, 4A, 5A, and 6A, the front face 21 of the second mirror portion 20 may be curved inwardly (concavely). As further shown in FIGS. IA-6A, the second mirror portion 20 may also be semi-cylindrical.

With continued reference to FIGS. 1-6, the first 10 and second mirror portions 20 may be substantially rectangular, having first 14, 24 and second sides 15, 25 and shorter first 16, 26 and second ends 17, 27. The first 10 and second mirror portions 20 may be distinct mirror portions or they may be portions of a single mirror. The first 10 and second mirror portions 20 may be distinctly framed 50a, 50b, 50c. The frame 50a may be wood, plastic, metal or any other material selected with sound engineering judgment. The frame 50a may be adapted to be removably or fixedly attached to other mirror portions 10, 20, 40 in the apparatus 1 or other frames 50b, 50c in the apparatus. The frame 50a may be adapted to be pivotably, and preferably, hingedly attached to other mirror portions 10, 20, 40 in the apparatus or other frames 50b, 50c in the apparatus 1.

The embodiments depicted in FIGS. 1-3 comprise first 10 and second 20 arcuate mirrors, the first mirror 10 being a mirror that magnifies and the second mirror 20 being a mirror that miniaturizes. The first 10 and second 20 mirrors depicted in FIGS. 1-3 are semi-cylindrical. Though the first mirror 10 is shown as being convex and, therefore, magnifying and the second mirror 20 is shown as being concave, and therefore miniaturizing, it will be understood that the order of the mirrors may be reversed.

The Planar Third Mirror Portion:

As shown in FIGS. 4-6, the apparatus may include a third mirror portion 40, which may be a substantially flat or planar, mirror portion. In this respect the third mirror portion 40 may have neither convex nor concave features to distort the image. The third mirror portion 40 may have a front face 41, a rear face 42, and at least a first edge 43. The third mirror portion 40 may be any shape, though round, square, and rectangular mirror portions are preferred shapes. The third mirror portion 40 may be substantially rectangular, having first 44 and second sides 45 and shorter first 46 and second ends 47. It should be understood that the third mirror portion 40 may be any shape selected with sound engineering judgment. The third mirror portion 40 may be surrounded by a frame 50c, which may be of wood, plastic, metal or any other material selected with sound engineering judgment. The frame 50c may be adapted to be removably or fixedly attached to the first 10 and/or second mirror portions 20 or their respective frames 50a, 50b, which may be similarly framed. Additionally, the frame 50c may be adapted to be hingedly attached to the first 10 and/or second 20 mirror portions or respective frames 50a, 50b.

The Inter-Relationship of the Three Mirror Portions:

In one general embodiment shown in FIGS. 4-6, the apparatus 1 may comprise the first IO, second 20 and third 40 mirror portions, which are preferably a magnifying first mirror portion 10, miniaturizing second mirror portion 20 and planar third mirror portion 40. The three mirror portions 10, 20, 40 may be connected to each other, preferably, but not necessarily, in the order of convex/magnifying, planar, concave/miniaturizing; however, any order may be selected in accordance with the present invention. In one embodiment, the three mirror portions may be portions of a single, uniform mirror consisting of a single piece of transparent material that is molded into the three mirror portions. In another embodiment, the three mirror portions may be separate mirrors that are either removably or fixedly connected to each other. For example, the three mirror portions 10, 20, 40 may be set in a single frame adapted to receive each mirror portion. Alternatively, each mirror portion 10, 20, 40 may be in a separate frame, as described above and each frame 50a, 50b, 50c may be affixed adjacent the next, such as with adhesives, or mechanical fixtures. In yet another embodiment, the frames 50a, 50b, 50c may be adapted to be removably connected to an adjacent frame. For example, each frame 50a, 50b, 50c may be provided with posts on one edge thereof that may be received into slots formed on an edge of the frame of an adjacent mirror. To connect the three mirror portions together, the posts on one frame may be slipped in to the slots provided on the adjacent mirror frame. This may allow for the mirror portions 10, 20, 40 to be disassembled for storage or to be rearranged. In yet another embodiment, the three mirror portions 10, 20, 40 may be three separate mirrors that are pivotably communicated with each other, and may be hingedly connected to each other. Any other means for selectively attaching the mirror portions 10, 20, 40 together may be selected with sound engineering judgment.

It is noted that FIGS. 1-3 depict embodiments wherein only two 10, 20 of the three mirror portions are included in the apparatus 1. In these embodiments, it is preferable to include the concave 20 and convex 10 mirror portions; however, any selection of mirror portions may be used in conjunction with each other.

The Size of the Three Mirror Portions:

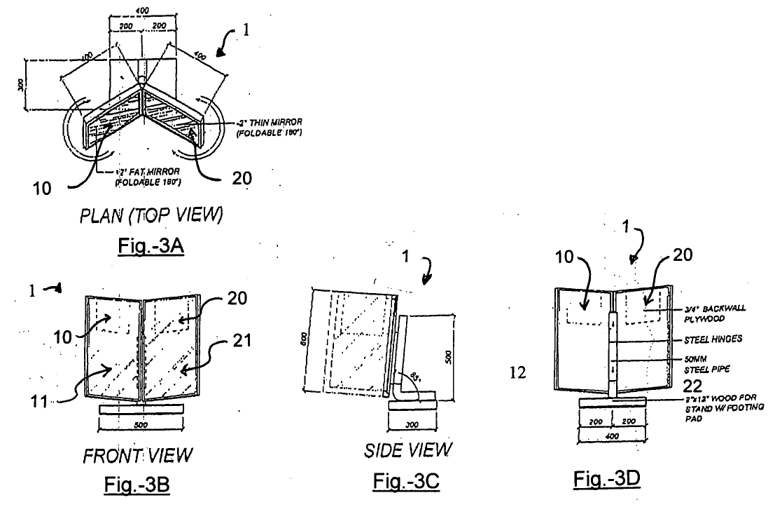

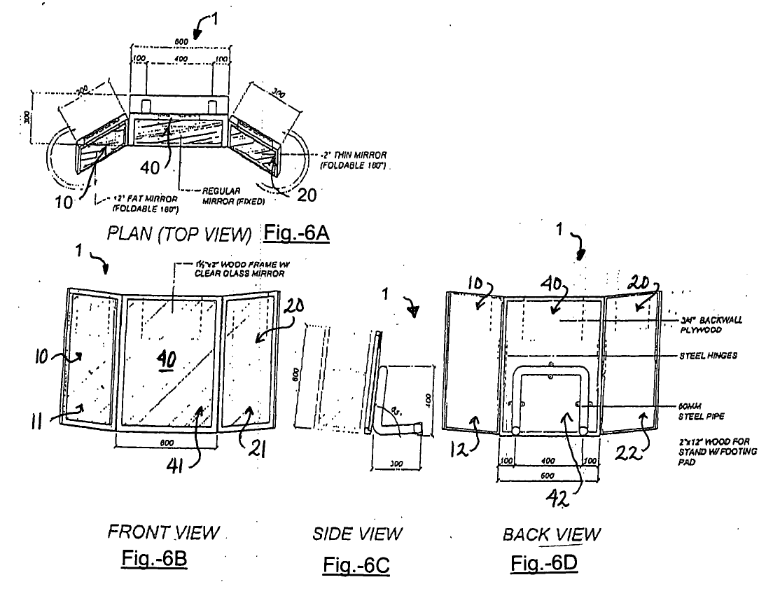

In one embodiment (shown in FIGS. 3 and 6), each of the mirror portions 10, 20, 40, including frames 50a, 50b, 50c, if present, may be of a size selected to be suitable for placing on a table top. For example, where the mirror portions are rectangular, the longer edges 14, 24, 44, 15, 25, 45 may be between approximately 600 and 1,000 millimeters (24 and 39 inches) and the shorter edges 16, 26, 46, 17, 27, 47 may be between approximately 300 and 700 millimeters (12 and 28 inches). However, it should be understood that each mirror may be configured either horizontally or vertically, meaning the longer edges 14, 24, 44, 15, 25, 45 may be horizontal or vertical. In the circular embodiment, the mirror portions 10, 20, 40 may have a diameter of between approximately 100 and 1,000 millimeters (4 and 39 inches).

In an alternate embodiment (depicted in FIGS. 1 and 4), the mirror portions 10, 20, 40 may be of a size suitable for use in providing a substantially full length image of the associated user. For example, where the mirror portions 10, 20, 40 are rectangular the longer edges 14, 24, 44, 15, 25, 45 may be between approximately 1,000 and 2,500 millimeters (39 and 90 inches) and the shorter edges 16, 26, 46, 17, 27, 47 may be between approximately 300 and 800 millimeters (12 and 32 inches).

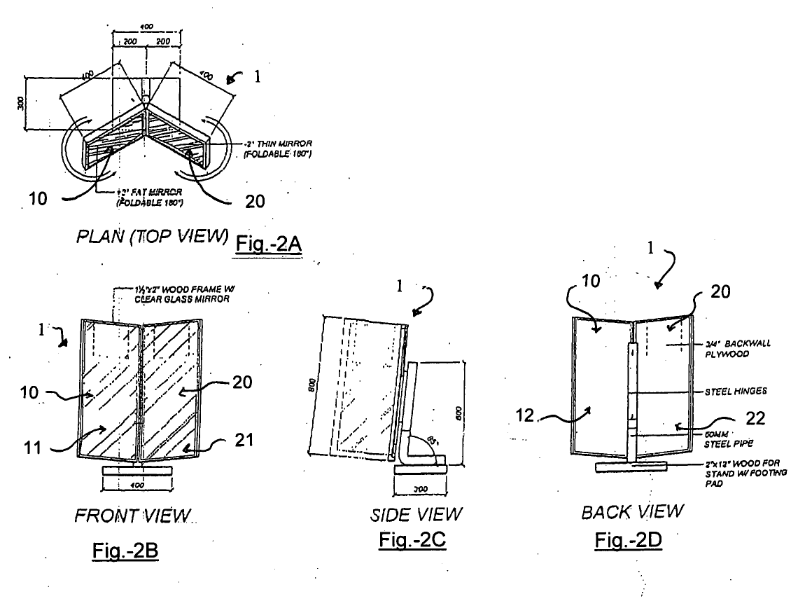

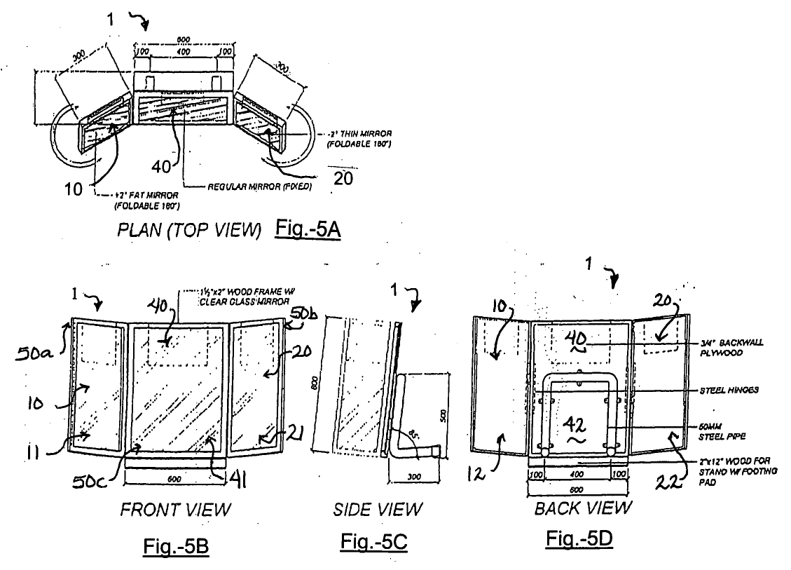

In a third embodiment (depicted in FIGS. 2 and 5), the mirror portions 10, 20, 40, including frames 50a, 50b, 50c, if present, may be of a size suitable for carrying in a bag or purse, or for use in a bathroom, where space may be restricted. For example, where the mirror portions 10, 20, 40 are rectangular, the longer edges 14, 24, 44, 15, 25, 45 may be between approximately 100 and 400 millimeters (4 and 16 inches) and the shorter edges 16, 26, 46, 17, 27, 47 may be between approximately 50 and 300 millimeters (2 and 12 inches). In a circular embodiment, the mirror portions 10, 20, 40 may have a diameter of between approximately 50 and 250 millimeters (2 and 10 inches). The size of the mirror portions is not intended to be limiting and may be selected in accordance with the preferred use of the apparatus as discussed below.

Accessories to the Apparatus:

In one embodiment (shown in FIG. 1B), the apparatus 1, whether having two 10, 20 or three mirror portions 10, 20, 40, may include a visual stimulating means 60, which may be an array 62 of one or more lights 65, 66. The light array 62 may be located adjacent to and is preferably at the top or bottom of the mirror portions 10, 20, 40, though the light array 62 may be placed along the edges of the mirror portions 10, 20, 40. In another embodiment (not shown), the light array 62 may be separate from the mirror portions 10, 20, 40 and selectively positionable in relation to them. The light array 62 may include a switch 67 for activating the array 62. Further, the light array 62 may be provided with a primary and secondary power supply, wherein the primary power supply may be a power cord and the secondary power supply may be a battery. In an alternate embodiment the light array 62 may only include a primary power supply, which may be a battery.

The light array 62 may include a plurality of distinct lights 65, 66. The lights 65, 66 may be in a single row. The lights 65, 66 may be white lights or colored lights. The lights 65, 66 may be incandescent, LED, halogen, fluorescent, or any other type of light selected with sound judgment. The lights 65, 66 may provide visual stimulation to the associated user when the associated user is using the apparatus 1. The visual stimulation may result from selective operation of the lights 65, 66. In this way, there may be provided a control, which may be incorporated with the switch 67 for controlling the lights according to programmed or pre-programmed instructions.

The lights 65, 66 may have the selectively controllable functions of dimming, flashing, dancing, highlighting different mirrors, and alternating between different mirror portions. For example, the lights 65, 66 may serve to focus the user's attention on a particular mirror portion according to a particular schedule or set of instructions.

The apparatus 1 may also include an auditory stimulating means 70 for emitting sounds to the associated user (see FIG. 1B. The auditory stimulating means 70 may include means for playing sounds, including music. Means may include compact disc or audio tape players, mp3 players, record players, radios or any other means for playing recorded sounds. The auditory stimulating means 70 may have the ability to record sounds, including, for example, the user's voice. The auditory stimulating means 70 may be programmed in conjunction with the light array 62 so that sound emitting from the auditory stimulating means 70 may be coordinated with the light array 62.

The apparatus 1 may also include olfactory stimulating means (not shown) for emitting various odors to the associated user. The olfactory stimulating means may include a burner, which may be a burner for incense or fragrant oils.

The apparatus may also include a stand 100 adapted for receiving either of both of a two mirror design or a three mirror design in order to hold the mirror portions 10, 20, 40 in a substantially upright position. The mirror portions 10, 20, 40 may be selectively removable from the stand. The apparatus 1 may include means for mounting the mirror portions 10, 20, 40 to a surface, such as a wall. Suitable mounting means may include adhesives and mechanical fasteners.

Using the Apparatus:

Now various methods of using the apparatus 1 described above are taught. In one aspect, the table top apparatus of the present invention, which is described above and depicted in FIGS. 3 and 6, may be placed on the table during a meal. The user may view himself in one of the mirror portions from time to time, while eating, which may be facilitated by instructions from the auditory or visual stimulating means. Focusing on a selected mirror portion while eating may encourage awareness of what and how much is being eaten. The associated user may look into the convex mirror portion 10 as means of evaluating and visualizing weight gain. Alternatively, the associated user may look into the concave mirror portion 20 as means of evaluating and visualizing weight loss. These visualizations may help the associated user determine what weight goal is desirable and may help the associated user make better determinations about what to eat. The individual who is looking to lose weight may focus on the concave mirror portion 20 so to have a visual image of the weight loss goal. Alternatively, the individual may look at the convex mirror portion 10 so to have a visual image of what further weight gain will look like. Having these images present during mealtime may remind the user to exercise discipline in eating during the meal. Comparing the two visualizations to the normal visage reflected in the planar mirror portion 40 provides important visual positive and negative goals.

The user may, on looking at the mirror portions that show the preferred body image, listen to or verbalize positive sounds or affirmational statements. The user may, on looking at the mirror portions that show the negative body image, listen to or verbalize negative sounds or statements to reinforce the negative image.

The larger, full-size apparatus 1 (depicted in FIGS. 1 and 4) may be placed in a room, such as a bedroom, closet or bathroom, and one may obtain a full figure visualization of weight gain and weight loss. The user may compare the two visualizations (magnification and miniaturization) to the normal figure reflected in the planar mirror portion 40.

The apparatus 1 may be used in conjunction with one or more of the visual, audio, and olfactory stimulating 60, 70 means to focus the associated user on the visual images presented in the two 10, 20, or alternatively, three mirror portions 10, 20, 40. As mentioned above, the visual stimulating means 60, which may be an array 62 of one or more lights 65, 66, may direct the user to a particular mirror portion. The image may be reinforced by sounds emitting from the audio stimulating means 70, which may be, for example, positive and negative affirmational statements that have been recorded.

Additionally, the method may include the steps of verbally reciting positive and negative affirmational statements in conjunction with viewing one or more of the concave and convex images in the apparatus. The positive affirmational statements may be recited while viewing the image that reflects the preferred or goal body shape. This may create further positive associations in the mind of the associated user to focus on meeting the weight goal demonstrated in the given mirror. The negative affirmational statements may be recited while viewing the image that reflects the non-preferred or avoidable body weight. This may create further negative associations in the mind of the associated user to focus on avoiding the lifestyle and eating habits that lead to the non-preferred body weight demonstrated in the given mirror.

It is anticipated that the method taught herein may be repeated throughout the day, during mealtimes, in the morning and evening when the associated user may be in the area of a full-size apparatus 1, or any other time the apparatus 1 is available to be viewed.

While is specifically disclosed that mirrors may be used to produce an image that is magnified or miniaturized, and thereby, to illustrate weight loss or weight gain for purposes of visualization, it will be note that other means for simulating these images may be selected. For example, the digitally or mechanically (by means of lenses, for example) manipulated photographs may be used in place of mirrors to show the associated user what his or her weight loss or weight gain would look like. Mirrors are desirable because the user can visualize him or herself while eating or partaking in some other activity, such as exercise.

Other aspects of the invention may be contained, described, or depicted in the documents and drawings filed herewith.

Having thus described the invention, it is now claimed:

1. An apparatus comprising:
a first magnifying mirror;
a second miniaturizing mirror; and
a third, substantially planar mirror.

2. The apparatus of claim 2, wherein the first mirror is convex and the second mirror is concave.

3. The apparatus of claim 3, wherein the third mirror is pivotably connected to each of the first and second mirrors.

4. The apparatus of claim 4, wherein the first and second mirrors have a length of between about 1,000 and 2,500 millimeters.

5. The apparatus of claim 1, further comprising a stand adapted to receive at least one of the first, second or third mirrors.

6. The apparatus of claim 1, further comprising a light array positioned adjacent at least one of the first, second, or third mirrors, the array comprising at least a first light.

7. The apparatus of claim 1 further comprising an auditory stimulating means.

8. The apparatus of claim 7, wherein the auditory stimulating means is selected from the group consisting of compact disc players, audio tape players, and digital music players.

9. The apparatus of claim 8, further comprising a burner adapted to burn one or more of fragrant oil and incense.

10. A weight control apparatus comprising:
A first mirror, the first mirror adapted to reflectively magnify an associated object; and
A second mirror, the second mirror adapted to reflectively miniaturize the associated object.

11. The apparatus of claim 10, further comprising a light array positioned adjacent at least one of the first and second mirrors, the array comprising at least a first light.

12. The apparatus of claim 11, wherein the first and second mirrors have a length of between about 600 and about 1000 mm.

13. The apparatus of claim 12, wherein the first mirror is pivotably attached to the second mirror.

14. The apparatus of claim 10 further comprising a third mirror, the third mirror adapted to reflect the associated object without magnification or miniaturization.

15. A weight control method comprising the steps of:
providing an apparatus, the apparatus comprising
a first magnifying reflective surface; and
a second miniaturizing reflective surface;
looking into one of the first or second surfaces; and
looking into the other of the first or second surfaces.

16. The method of claim 15, further comprising the step of:
Eating while looking into the first and second surfaces.
